(19) United States
(12) Patent Application Publication
(10) Pub. No.: US 2021/0398520 A1
(43) Pub. Date: Dec. 23, 2021

(54) INFORMATION PROCESSING DEVICE AND PROGRAM

(71) Applicant: SONY CORPORATION, TOKYO (JP)

(72) Inventor: REIKO KIRIHARA, TOKYO (JP)

(21) Appl. No.: 17/287,397

(22) PCT Filed: Sep. 11, 2019
(86) PCT No.: PCT/JP2019/035741

§ 371 Date: Apr. 21, 2021

(30) Foreign Application Priority Data
Oct. 31, 2018 (JP) 2018-204770

(51) Int. Cl. G10L 15/08; G06K 9/00

(52) U.S. Cl. CPC G10L 15/08; G06K 9/00228

(57) ABSTRACT

A program according to one embodiment of the present disclosure causes an information processing device configured to perform voice recognition to execute a step of setting a voice recognition mode to a minimum utterance rejection mode if a predetermined condition is satisfied during the voice recognition.

### TECHNICAL FIELD

The present disclosure relates to an information processing device configured to perform voice recognition and to a program executable by the information processing device configured to perform voice recognition.

### BACKGROUND ART

In recent years, a technique of starting an application by voice recognition has been developed (e.g., see PTL 1).

### CITATION LIST

### Patent Literature

PTL 1: Japanese Unexamined Patent Application Publication No. 2017-207602

### SUMMARY OF THE INVENTION

Incidentally, when an application is started by voice recognition, it is desired to reduce user burden imposed for utterance by starting the application by an utterance as short as possible (hereinafter referred to as “minimum utterance”). For example, it is desired to make it possible to play music by simply saying “music” instead of “play music”. However, when attempting to start an application by a minimum utterance, there has been a concern that probability of occurrence of a malfunction increases due to surrounding utterances and noises. Therefore, it is desirable to provide an information processing device and a program that make it possible to reduce the probability of occurrence of a malfunction in a case of attempting to start an application by a minimum utterance.

An information processing device according to one embodiment of the present disclosure includes a mode controller that sets a voice recognition mode to a minimum utterance rejection mode if a predetermined condition is satisfied during voice recognition.

A program according to one embodiment of the present disclosure causes an information processing device configured to perform voice recognition to execute a step of setting a voice recognition mode to a minimum utterance rejection mode if a predetermined condition is satisfied during the voice recognition.

In the information processing device and the program according to one embodiment of the present disclosure, the voice recognition mode is set to the minimum utterance rejection mode if the predetermined condition is satisfied during the voice recognition. This enables command input based on a minimum utterance to be rejected in a situation where a malfunction is likely to occur.

### BRIEF DESCRIPTION OF DRAWINGS

FIG. 1 is a diagram illustrating an example schematic configuration of an information processing system including an agent according to a first embodiment of the present disclosure.

FIG. 2 is a diagram illustrating an example schematic configuration of the agent in FIG. 1.

FIG. 3 is a diagram illustrating exemplary functional blocks of a controller in FIG. 2.

FIG. 4 is a diagram illustrating a flow chart of operation in the controller in FIG. 1.

FIG. 5 is a diagram illustrating a flow chart of operation in the controller in FIG. 1.

FIG. 6 is a diagram illustrating a flow chart of operation in the controller in FIG. 1.

FIG. 7 is a diagram illustrating an example of screen display in a case where a voice recognition mode is a normal mode.

FIG. 8 is a diagram illustrating an example of screen display in a case where the voice recognition mode is a rejection mode.

FIG. 9 is a diagram illustrating an example schematic configuration of an information processing system including an agent according to a second embodiment of the present disclosure.

FIG. 10 is a diagram illustrating an example schematic configuration of the agent in FIG. 9.

FIG. 11 is a diagram illustrating an example schematic configuration of an agent assistance server device in FIG. 9.

FIG. 12 is a diagram illustrating exemplary functional blocks of a controller in FIG. 10.

FIG. 13 is a diagram illustrating exemplary functional blocks of a controller in FIG. 11.

### MODES FOR CARRYING OUT THE INVENTION

In the following, description is given of embodiments of the present disclosure in detail with reference to the drawings. Note that, in this specification and the accompanying drawings, components that have substantially the same function and configuration are denoted by the same reference signs, and thus redundant description thereof is omitted. Description is given in the following order.

### 1. First Embodiment

An example in which an agent executes voice command processing alone

### 2. Second Embodiment

An example in which an agent and a networked server device work in collaboration to execute voice command processing

### 1. First Embodiment

### [Configuration]

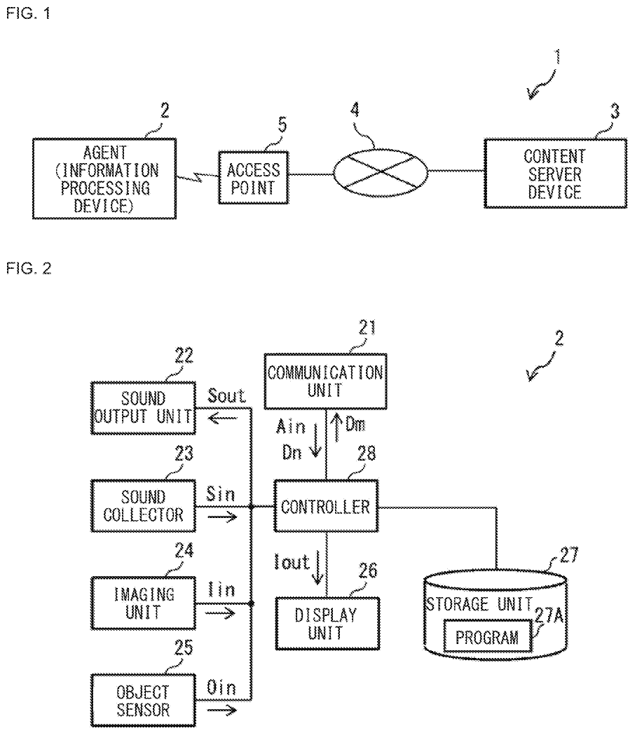

An information processing system 1 including an agent 2 according to a first embodiment of the present disclosure will be described. FIG. 1 illustrates an example schematic configuration of the information processing system 1. The information processing system 1 includes the agent 2 (information processing device), a content server device 3, a network 4, and an access point 5. The agent 2, on behalf of a user, executes processing of the user's request (specifically, a voice command). The following assumes that the user inputs the voice command to the agent 2 and that the voice command processing is executed by the agent 2.

The agent 2 is coupled to the network 4 via the access point 5. The content server device 3 is coupled to the network 4 via a predetermined communication apparatus. The access point 5 is configured to be wirelessly coupled to a Wi-Fi terminal. The agent 2 communicates with the content server device 3 via the access point 5 through wireless LAN communication. The network 4 is, for example, a network that performs communication using a communication protocol (TCP/IP) that is ordinarily used on the Internet. In response to a request from a terminal (e.g., the agent 2) coupled to the access point 5, the access point 5 transmits (returns) MAC addresses of all apparatuses coupled to the access point 5.

FIG. 2 illustrates an example schematic configuration of the agent 2. The agent 2 includes, for example, a communication unit 21, a sound output unit 22, a sound collector 23, an imaging unit 24, an object sensor 25, a display unit 26, a storage unit 27, and a controller 28.

The communication unit 21 transmits a request Dm to the access point 5 under the control of the controller 28. In a case where the request Dm is a request for content, the access point 5 transmits the request Dm to the content server device 3 via the network 4. Upon receiving the request Dm, the content server device 3 transmits content Dn corresponding to the request Dm to the agent 2 (the communication unit 21) via the access point 5. In a case where the request Dm is a request for the MAC addresses of all the apparatuses coupled to the access point 5, the access point 5 transmits the MAC addresses of all the apparatuses coupled to the access point 5 to the agent 2 (the communication unit 21).

The sound output unit 22 is a loudspeaker, for example. The sound output unit 22 outputs voice on the basis of a voice signal Sout inputted from the controller 28. The sound collector 23 is a microphone, for example. The sound collector 23 transmits obtained sound (Sound) Sin to the controller 28. The imaging unit 24 is a camera, for example. The imaging unit 24 transmits obtained image data Iin to the controller 28. The object sensor 25 is an infrared sensor, for example. The object sensor 25 transmits obtained observation data Oin to the controller 28. The display unit 26 is, for example, a liquid crystal panel or an organic EL (Electro Luminescence) panel. The display unit 26 displays an image on the basis of an image signal Tout inputted from the controller 28.

The storage unit 27 is, for example, a volatile memory such as a DRAM (Dynamic Random Access Memory), or a non-volatile memory such as an EEPROM (Electrically Erasable Programmable Read-Only Memory) or a flash memory. The storage unit 27 has a program 27A stored therein that executes the voice command processing. The program 27A includes a series of steps for execution of the voice command processing. The controller 28 is constituted by a processor, for example. The controller 28 executes the program 27A stored in the storage unit 27. Functions of the controller 28 are implemented, for example, by executing the program 27A by the processor. The series of steps implemented by the program 27A will be described in detail later.

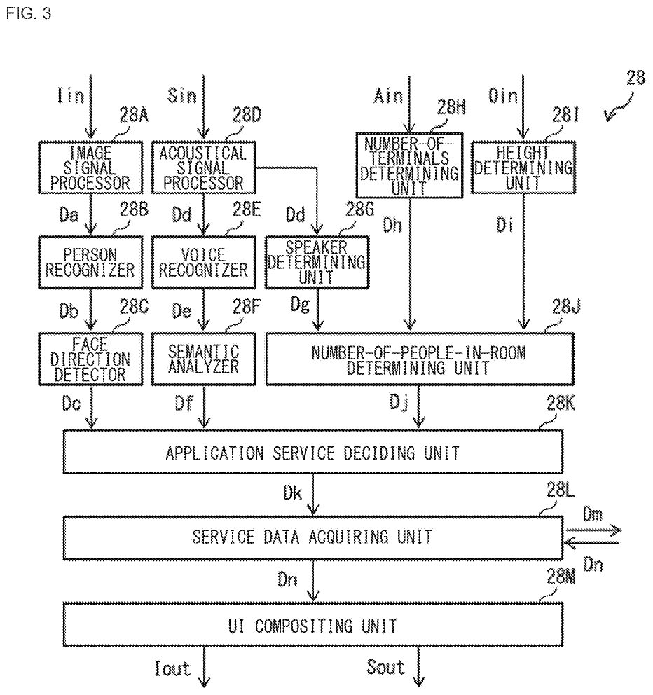

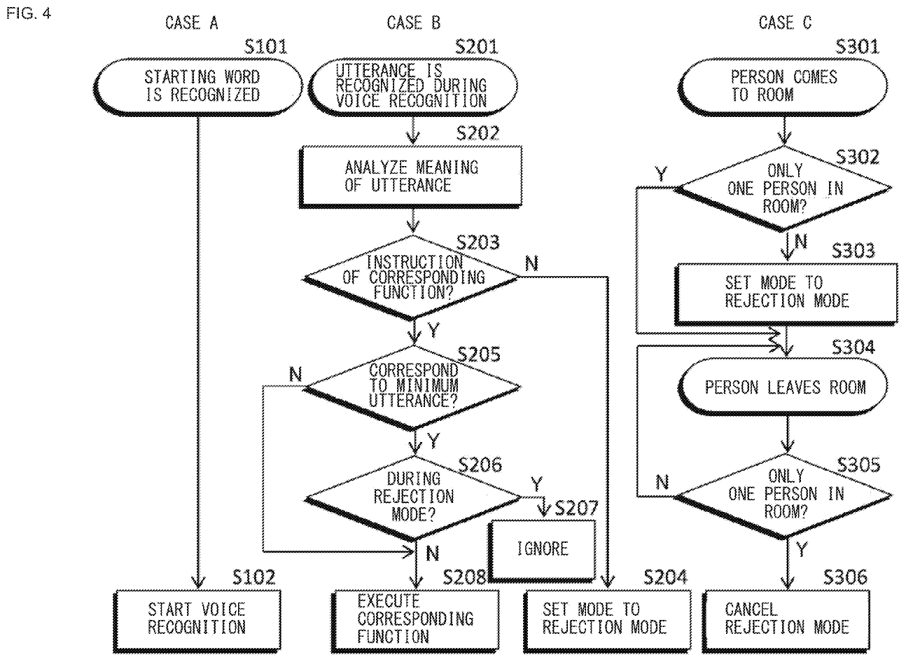

FIG. 3 illustrates exemplary functional blocks of the controller 28. The controller 28 includes, for example, an image signal processor 28A, a person recognizer 28B, a face direction detector 28C, an acoustical signal processor 28D, a voice recognizer 28E, a semantic analyzer 28F, a speaker determining unit 28G, a number-of-terminals determining unit 28H, a height determining unit 28I, and a number-of-people-in-room determining unit 28J. The controller 28 executes the respective functions of the image signal processor 28A, the person recognizer 28B, the face direction detector 28C, the acoustical signal processor 28D, the voice recognizer 28E, the semantic analyzer 28F, the speaker determining unit 28G, the number-of-terminals determining unit 28H, the height determining unit 28I, and the number-of-people-in-room determining unit 28J, for example, by executing the program 27A stored in the storage unit 27.

The image signal processor 28A performs predetermined signal processing on the image data Iin obtained by the imaging unit 24, thereby making the image data Iin suitable for signal processing in the subsequent person recognizer 28B and face direction detector 28C. The image signal processor 28A outputs thus generated image data Da to the person recognizer 28B. The person recognizer 28B detects a person included in the image data Da generated by the image signal processor 28A, and extracts image data Db of a region where the person has been detected, from the image data Da. The person recognizer 28B outputs the extracted image data Db to the face direction detector 28C. The face direction detector 28C detects a face direction of the person included in the image data Db generated by the person recognizer 28B. The face direction detector 28C outputs information (face direction data Dc) about the detected face direction to an application service deciding unit 28K (described later). According to the above, the image signal processor 28A, the person recognizer 28B, and the face direction detector 28C detect the face direction of a speaker on the basis of the image data Iin obtained by the imaging unit 24.

The acoustical signal processor 28D extracts information (voice data Dd) about human voice from the sound data Sin obtained by the sound collector 23. The acoustical signal processor 28D outputs the extracted voice data Dd to the voice recognizer 28E and the speaker determining unit 28G. The voice recognizer 28E converts the voice data Dd extracted by the acoustical signal processor 28D into text data De. The voice recognizer 28E outputs the converted text data De to the semantic analyzer 28F. The semantic analyzer 28F analyzes the meaning of the text data De converted by the voice recognizer 28E. The semantic analyzer 28F outputs data (an analysis result DO obtained by the analysis to the application service deciding unit 28K (described later). According to the above, the acoustical signal processor 28D, the voice recognizer 28E, and the semantic analyzer 28F detect an utterance on the basis of the sound data Sin obtained by the sound collector 23.

The speaker determining unit 28G determines the number of speakers included in the voice data Dd from the voice data Dd extracted by the acoustical signal processor 28D, and consequently outputs obtained information (number-of-speakers data Dg) about the number of speakers to the number-of-people-in-room determining unit 28J. That is, the acoustical signal processor 28D and the speaker determining unit 28G detect the number of speakers on the basis of the sound data Sin obtained by the sound collector 23. The number-of-terminals determining unit 28H outputs, as the request Dm, a request for the MAC addresses of all the apparatuses coupled to the access point 5 to the communication unit 21. Upon acquiring information (address data Ain) about the MAC addresses of all the apparatuses coupled to the access point 5 from the communication unit 21, the number-of-terminals determining unit 28H derives, from the acquired address data Ain, the number of apparatuses coupled to the access point 5, excluding the agent 2. The number-of-terminals determining unit 28H outputs information (number-of-apparatuses data Dh) about the derived number of apparatuses to the number-of-people-in-room determining unit 28J. That is, the number-of-terminals determining unit 28H detects the number of apparatuses coupled to the access point 5, excluding the agent 2, on the basis of the information of the apparatus coupled to the access point 5 acquired via the communication unit 21. The height determining unit 28I derives the size of an object from the observation data Oin obtained by the object sensor 25, and determines whether or not the derived size of the object is within a range that may be taken as a human height. The height determining unit 28I consequently determines the object as a person in a case where the derived size of the object is within the range that may be taken as a human height. The height determining unit 28I outputs information (number-of-people data Di) about the number of objects determined as persons to the number-of-people-in-room determining unit 28J. That is, the height determining unit 28I detects the number of people in a room on the basis of the size of the object obtained by the object sensor 25.

The number-of-people-in-room determining unit 28J determines the number of people in the room, on the basis of at least one of the number-of-speakers data Dg inputted from the speaker determining unit 28G, the number-of-apparatuses data Dh inputted from the number-of-terminals determining unit 28H, or the number-of-people data Di inputted from the height determining unit 28I. The number-of-people-in-room determining unit 28J outputs the obtained number of people in the room Dj to the application service deciding unit 28K (described later).

The controller 28 further includes, for example, the application service deciding unit 28K, a service data acquiring unit 28L, and a UI compositing unit 28M. The controller 28 executes the respective functions of the application service deciding unit 28K, the service data acquiring unit 28L, and the UI compositing unit 28M, for example, by executing the program 27A stored in the storage unit 27.

The application service deciding unit 28K decides whether to execute or not execute (ignore) an application or one function (corresponding function) included in the application, on the basis of the detection result Dc, the analysis result Df, and the number of people in the room Dj.

Specifically, the application service deciding unit 28K first determines whether or not the analysis result Df corresponds to an instruction (i.e., voice command) of an application or one function (corresponding function) included in the application. In other words, the application service deciding unit 28K determines, on the basis of the analysis result Df, whether or not the utterance includes a non-corresponding utterance (i.e., an utterance different from a voice command). Consequently, in a case where the analysis result Df corresponds to a voice command, the application service deciding unit 28K sets a voice recognition mode to a normal mode. On the other hand, in a case where the analysis result Df does not correspond to a voice command (that is, the utterance includes a non-corresponding utterance), the application service deciding unit 28K sets the voice recognition mode to a minimum utterance rejection mode.

Here, the “normal mode” refers to a mode in which a minimum utterance is accepted as a voice command. The “minimum utterance” refers to, when giving an instruction for execution of an application or one function (corresponding function) included in the application, an utterance (e.g., a word) as short as possible indicating the instruction. For example, “music” for “play music” corresponds to the “minimum utterance”. The application service deciding unit 28K sets the voice recognition mode to the minimum utterance rejection mode in a case where the detection result Dc is “the user is not facing the device body”. The “minimum utterance rejection mode” refers to a mode in which the “minimum utterance” is not accepted as a voice command and is ignored.

The application service deciding unit 28K then sets the voice recognition mode on the basis of the detection result Dc and the number of people in the room Dj. The application service deciding unit 28K determines whether or not the face of the speaker is facing the agent 2 on the basis of the face direction of the speaker detected by the face direction detector 28C. Specifically, the application service deciding unit 28K sets the voice recognition mode to the normal mode in a case where it determines that “the user is facing the device body” on the basis of the detection result Dc. On the other hand, the application service deciding unit 28K sets the voice recognition mode to the minimum utterance rejection mode in a case where it determines that “the user is not facing the device body” on the basis of the detection result Dc. In addition, the application service deciding unit 28K determines whether or not the number of people in the room is two or more, on the basis of the number of people in the room (the number of speakers, the number of apparatuses excluding the agent 2, or the number of people in the room) detected by the number-of-people-in-room determining unit 28J. Specifically, the application service deciding unit 28K sets the voice recognition mode to the normal mode in a case where it determines that the number of people in the room is not two or more on the basis of the number of people in the room Dj. The application service deciding unit 28K sets the voice recognition mode to the minimum utterance rejection mode in a case where it determines that the number of people in the room is two or more on the basis of the number of people in the room Dj.

The application service deciding unit 28K then decides whether to execute or not execute (ignore) an application or one function (corresponding function) included in the application, on the basis of the voice recognition mode and the analysis result Df. That is, the application service deciding unit 28K decides whether to execute or not execute (ignore) a voice command on the basis of the voice recognition mode and the analysis result Df.

In a case where the voice recognition mode is set to the normal mode, the application service deciding unit 28K executes the application, or one function (corresponding function) included in the application, corresponding to the analysis result Df. That is, in this case, the application service deciding unit 28K executes the voice command corresponding to the analysis result Df.

On the other hand, in a case where the voice recognition mode is set to the minimum utterance rejection mode and where the analysis result Df corresponds to a minimum utterance, the application service deciding unit 28K ignores the analysis result Df, without executing the application, or one function (corresponding function) included in the application, corresponding to the analysis result Df. That is, in this case, the application service deciding unit 28K does not execute the voice command corresponding to the analysis result Df. In addition, in a case where the voice recognition mode is set to the minimum utterance rejection mode and where the analysis result Df does not correspond to a minimum utterance, the application service deciding unit 28K executes the application, or one function (corresponding function) included in the application, corresponding to the analysis result Df. That is, in this case, the application service deciding unit 28K executes the voice command corresponding to the analysis result Df.

In a case of executing the voice command corresponding to the analysis result Df, the application service deciding unit 28K reports, to the service data acquiring unit 28L, information (application data Dk) about the application necessary for execution of the voice command corresponding to the analysis result Df.

The service data acquiring unit 28L generates the request Dm for content on the basis of the application data Dk reported from the application service deciding unit 28K, and transmits it to the communication unit 21. Upon receiving the content data Dn corresponding to the request Dm from the communication unit 21, the service data acquiring unit 28L transmits the received content data Dn to the UI compositing unit 28M.

The UI compositing unit 28M generates the image signal lout and the voice signal Sout on the basis of the content data Dn received from the service data acquiring unit 28L. The UI compositing unit 28M transmits the generated image signal lout to the display unit 26, and transmits the generated voice signal Sout to the sound output unit 22.

### [Operation]

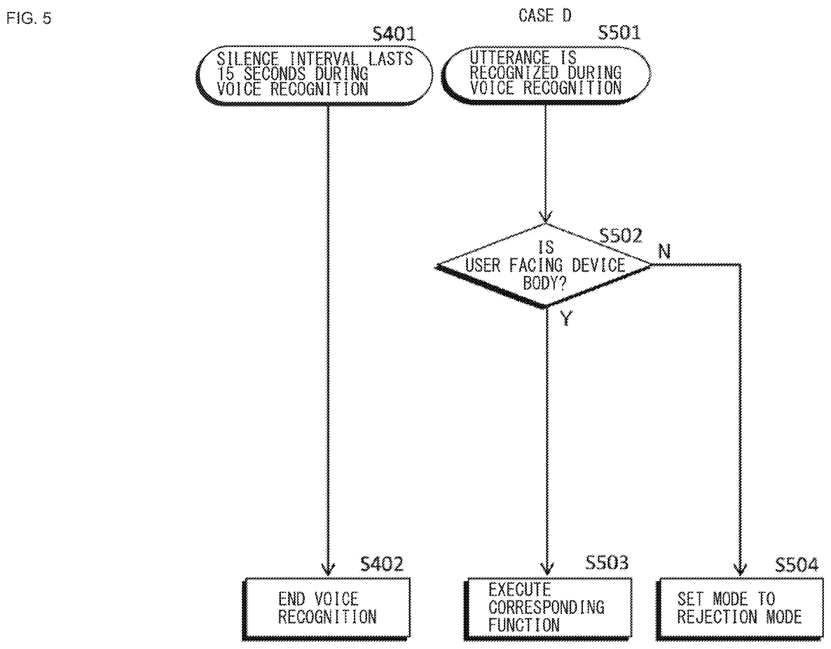

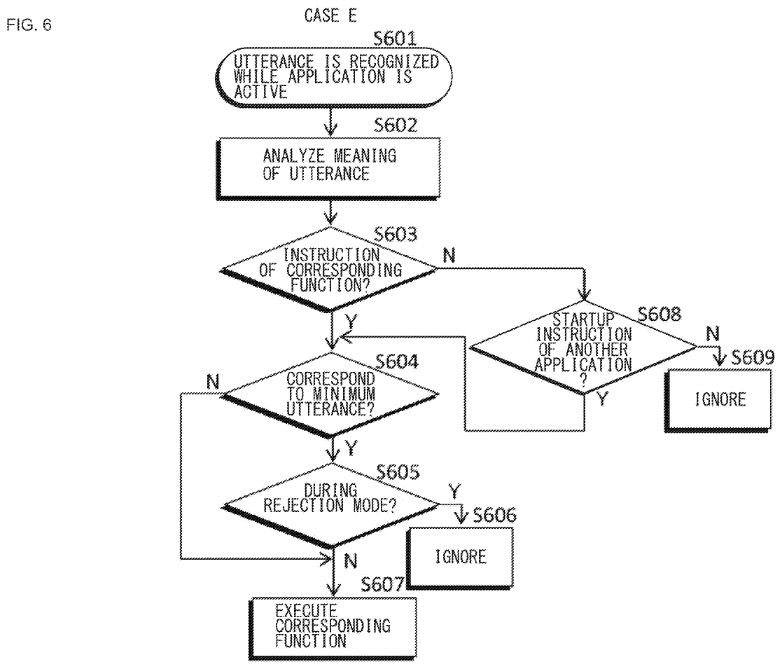

Next, operation in the agent 2 will be described. FIG. 4, FIG. 5, and FIG. 6 are diagrams illustrating flow charts of the operation in the agent 2 (the controller 28).

The agent 2 (the controller 28) determines whether or not a starting word is included in the analysis result Df generated on the basis of the sound data Sin. Consequently, in a case where it recognizes the starting word in the analysis result Df (S101), the agent 2 (the controller 28) sets the voice recognition mode to the voice recognition mode. In this case, the agent 2 (the controller 28) starts voice recognition (S102).

The agent 2 (the controller 28) determines whether or not an utterance is included in the sound data Sin obtained during the voice recognition. Consequently, in a case where it recognizes an utterance in the sound data Sin (S201), the agent 2 (the controller 28) analyzes the meaning of the utterance (S202). The agent 2 (the controller 28) sets the voice recognition mode to the minimum utterance rejection mode in a case where the utterance does not correspond to an instruction (i.e., voice command) of an application or one function (corresponding function) included in the application (S203, 204). On the other hand, the agent 2 (the controller 28) executes the following operation (S205 to 5208) in a case where the utterance corresponds to an instruction (i.e., voice command) of an application or one function (corresponding function) included in the application.

First, the agent 2 (the controller 28) determines whether or not the voice command corresponds to a minimum utterance (S205). Consequently, in a case where the voice command corresponds to a minimum utterance, the agent 2 (the controller 28) determines whether or not the voice recognition mode is the minimum utterance rejection mode (S206). Consequently, in a case where the voice recognition mode is the minimum utterance rejection mode, the agent 2 (the controller 28) ignores the voice command (S207). On the other hand, in a case where the voice command does not correspond to a minimum utterance, or in a case where the voice recognition mode is the minimum utterance rejection mode, the agent 2 (the controller 28) executes the instruction (i.e., voice command) of the application or one function (corresponding function) included in the application (S208).

In a case where a person comes to the room (S301), that is, in a case where the number of people in the room Dj obtained by the number-of-people-in-room determining unit 28J becomes one or more, the agent 2 (the controller 28) determines whether or not only one person is in the room (S302). Consequently, in a case where there are two or more people in the room, the agent 2 (the controller 28) sets the voice recognition mode to the minimum utterance rejection mode (S303). On the other hand, in a case where there is only one person in the room, the agent 2 (the controller 28) sets the voice recognition mode to the normal mode. After the execution of steps 5302 and 303, the agent 2 (the controller 28), in a case where a person leaves the room (S304), that is, in a case where the number of people in the room Dj obtained by the number-of-people-in-room determining unit 28J decreases, the agent 2 (the controller 28) determines whether or not there is only one person in the room (S305). Consequently, in a case where there is only one person in the room, the agent 2 (the controller 28) cancels the minimum utterance rejection mode (S306) and sets the voice recognition mode to the normal mode. The agent 2 (the controller 28) executes step 5305 each time a person leaves the room, that is, each time the number of people in the room Dj obtained by the number-of-people-in-room determining unit 28J decreases.

The agent 2 (the controller 28) ends the voice recognition mode (S401) in a case where a silence interval lasts 15 seconds during the voice recognition (S401). The agent 2 (the controller 28) determines whether or not an utterance is included in the sound data Sin obtained during the voice recognition. Consequently, in a case where the agent 2 (the controller 28) recognizes an utterance in the sound data Sin (S501), the agent 2 (the controller 28) determines whether or not the detection result Dc corresponds to “the user is facing the device body” (S502). Consequently, in a case where the detection result Dc corresponds to “the user is facing the device body”, the agent 2 (the controller 28) executes the utterance the instruction (i.e., voice command) of the application or one function (corresponding function) included in the application (S503). On the other hand, in a case where the detection result Dc corresponds to “the user is not facing the device body”, the agent 2 (the controller 28) does not execute the utterance the instruction (i.e., voice command) of the application or one function (corresponding function) included in the application, and sets the voice recognition mode to the minimum utterance rejection mode (S504).

The agent 2 (the controller 28) determines whether or not an utterance is included in the sound data Sin obtained while an application is active. Consequently, in a case where it recognizes an utterance in the sound data Sin (S601), the agent 2 (the controller 28) analyzes the meaning of the utterance (S602). In a case where the utterance does not correspond to an instruction (i.e., voice command) of one function (corresponding function) included in the active application, the agent 2 (the controller 28) determines whether or not the utterance included in the sound data Sin corresponds to a startup instruction of another application (S608). Consequently, the agent 2 (the controller 28) ignores the utterance included in the sound data Sin in a case where the utterance included in the sound data Sin does not correspond to the startup instruction of another application (S609).

On the other hand, in a case where the utterance corresponds to an instruction (i.e., voice command) of one function (corresponding function) included in the active application in step 5603, or corresponds to the startup instruction of another application, the agent 2 (the controller 28) determines whether or not the utterance included in the sound data Sin corresponds to a minimum utterance (S604). Consequently, in a case where the utterance included in the sound data Sin corresponds to a minimum utterance, the agent 2 (the controller 28) determines whether or not the voice recognition mode is the minimum utterance rejection mode (S605). Consequently, in a case where the voice recognition mode is not the minimum utterance rejection mode, the utterance included in the sound data Sin is ignored (S606). In a case where the voice recognition mode is the minimum utterance rejection mode, or in a case where the utterance included in the sound data Sin does not correspond to a minimum utterance in step 5604, the agent 2 (the controller 28) executes the utterance (i.e., voice command) included in the sound data Sin (S607).

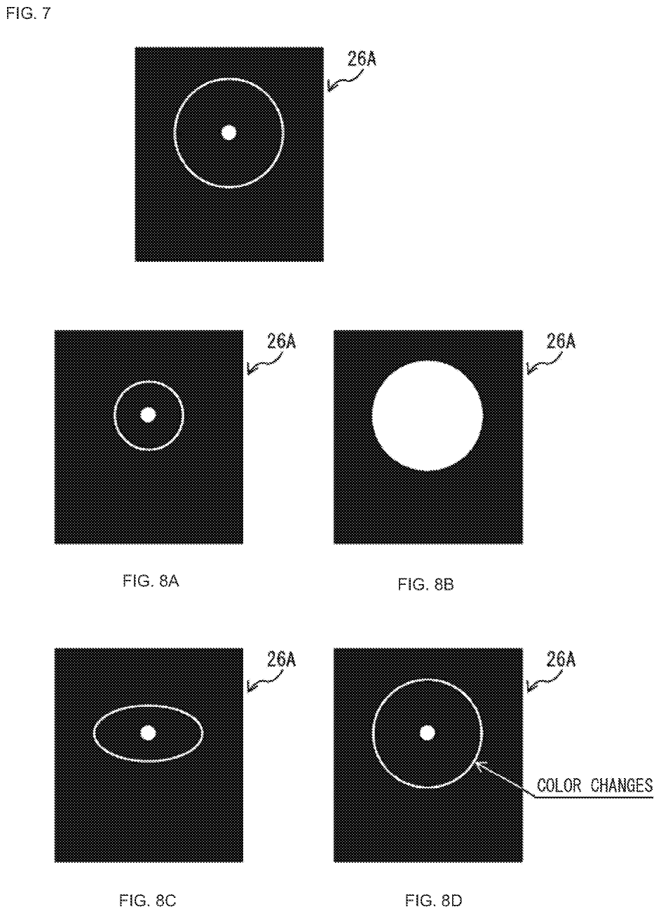

FIG. 7 illustrates an example of screen display in a case where the voice recognition mode is the normal mode. (A), (B), (C), and (D) of FIG. 8 each illustrate an example of screen display in a case where the voice recognition mode is the rejection mode. If the voice recognition mode is the normal mode, the agent 2 (the controller 28) generates an image signal lout that displays a picture schematically representing an eye, for example, as illustrated in FIG. 7, and outputs it to the display unit 26. Then, the display unit 26 displays the picture as illustrated in FIG. 7, for example, on a display screen 26A. If the voice recognition mode is the minimum utterance rejection mode, the agent 2 (the controller 28) generates an image signal lout that displays a picture schematically representing a smaller eye than in the normal mode, for example, as illustrated in (A) of FIG. 8, and outputs it to the display unit 26. Then, the display unit 26 displays the picture as illustrated in (A) of FIG. 8, for example, on the display screen 26A.

If the voice recognition mode is the minimum utterance rejection mode, the agent 2 (the controller 28) generates an image signal lout that displays a picture representing the whole eye lightly colored, for example, as illustrated in (B) of FIG. 8, and outputs it to the display unit 26. Then, the display unit 26 displays the picture as illustrated in (B) of FIG. 8, for example, on the display screen 26A. If the voice recognition mode is the minimum utterance rejection mode, the agent 2 (the controller 28) generates an image signal lout that displays a picture representing the eye thinner than in the normal mode, for example, as illustrated in (C) of FIG. 8, and outputs it to the display unit 26. Then, the display unit 26 displays the picture as illustrated in (C) of FIG. 8, for example, on the display screen 26A. If the voice recognition mode is the minimum utterance rejection mode, the agent 2 (the controller 28) generates an image signal lout that displays a picture with the outline of the eye changed in color, for example, as illustrated in (D) of FIG. 8, and outputs it to the display unit 26. Then, the display unit 26 displays the picture as illustrated in (D) of FIG. 8, for example, on the display screen 26A.

### [Effects]

Next, effects of the agent 2 will be described.

When an application is started by voice recognition, it is desired to reduce user burden imposed for utterance by starting the application by a minimum utterance. For example, it is desired to make it possible to play music by simply saying “music” instead of “play music”. However, when attempting to start an application by a minimum utterance, there has been a concern that probability of occurrence of a malfunction increases due to surrounding utterances and noises.

In contrast, in the agent 2 according to the present embodiment and a program 27B to be executed by the agent 2, the voice recognition mode is set to the minimum utterance rejection mode if a predetermined condition is satisfied during voice recognition. Here, the predetermined condition includes at least one of a case where the utterance detected during voice recognition is determined as being a non-corresponding utterance that does not correspond to an instruction of a corresponding function, a case where the face of the speaker detected during voice recognition is determined as not facing the information processing device, or a case where the number of people in the room detected during voice recognition is determined as being two or more. This enables command input based on a minimum utterance to be rejected in a situation where a malfunction is likely to occur, which makes it possible to reduce the probability of occurrence of a malfunction in a case where an instruction (i.e., voice command) of an application or one function (corresponding function) included in the application is executed by a minimum utterance.

Further, in the agent 2 according to the present embodiment and the program 27B to be executed by the agent 2, it is determined whether or not the face of the speaker is facing the agent 2 on the basis of the detected face direction of the speaker. Here, it is natural to consider that the face of the speaker is facing the agent 2 if the speaker speaks with the intention of inputting a voice command to the agent 2. Therefore, if the face of the speaker is not facing the agent 2, the speaker is likely to be making an utterance without the intention of inputting a voice command to the agent 2. However, even in a case where the face of the speaker is not facing the agent 2, the speaker is likely to be making an utterance with the intention of inputting a voice command to the agent 2 if the speaker makes an utterance longer than a minimum utterance. Therefore, determining whether to accept or reject a voice command based on a minimum utterance on the basis of the detected face direction of the speaker makes it possible to reduce the probability of occurrence of a malfunction.

Further, in the agent 2 according to the present embodiment and the program 27B to be executed by the agent 2, it is determined, on the basis of an utterance detected from the sound obtained by the sound collector 23, whether or not the utterance includes a non-corresponding utterance. This enables a voice command to be prevented from being accidentally executed on the basis of a non-corresponding utterance. Consequently, it is possible to reduce the probability of occurrence of a malfunction.

Further, in the agent 2 according to the present embodiment and the program 27B to be executed by the agent 2, it is determined whether or not the number of people in the room is two or more on the basis of the number of speakers detected by the object sensor 25. Here, in a case where two or more speakers are present, one speaker is likely to be talking with another speaker. That is, it is likely that two or more speakers are talking without the intention of inputting a voice command to the agent 2. Therefore, determining whether to accept or reject a voice command based on a minimum utterance on the basis of the number of speakers detected by the object sensor 25 makes it possible to reduce the probability of occurrence of a malfunction.

Further, in the agent 2 according to the present embodiment and the program 27B to be executed by the agent 2, it is determined whether or not the number of people in the room is two or more on the basis of the information of the apparatus coupled to the access point 5 acquired via the communication unit 21. Here, in a case where two or more apparatuses are present, excluding the agent 2, it is likely that two or more people are nearby the agent 2. In a case where two or more people are nearby the agent 2, they are likely to talk together without the intention of inputting a voice command to the agent 2. Therefore, determining whether to accept or reject a voice command based on a minimum utterance on the basis of the information of the apparatus coupled to the access point 5 acquired via the communication unit 21 makes it possible to reduce the probability of occurrence of a malfunction.

Further, in the agent 2 according to the present embodiment and the program 27B to be executed by the agent 2, it is determined whether or not the number of people in the room is two or more on the basis of the size of the object obtained by the object sensor 25. Here, in a case where the number of people in the room is two or more, they are likely to talk together without the intention of inputting a voice command to the agent 2. Therefore, determining whether to accept or reject a voice command based on a minimum utterance on the basis of the size of the object obtained by the object sensor 25 makes it possible to reduce the probability of occurrence of a malfunction.

### 2. Second Embodiment

### [Configuration]

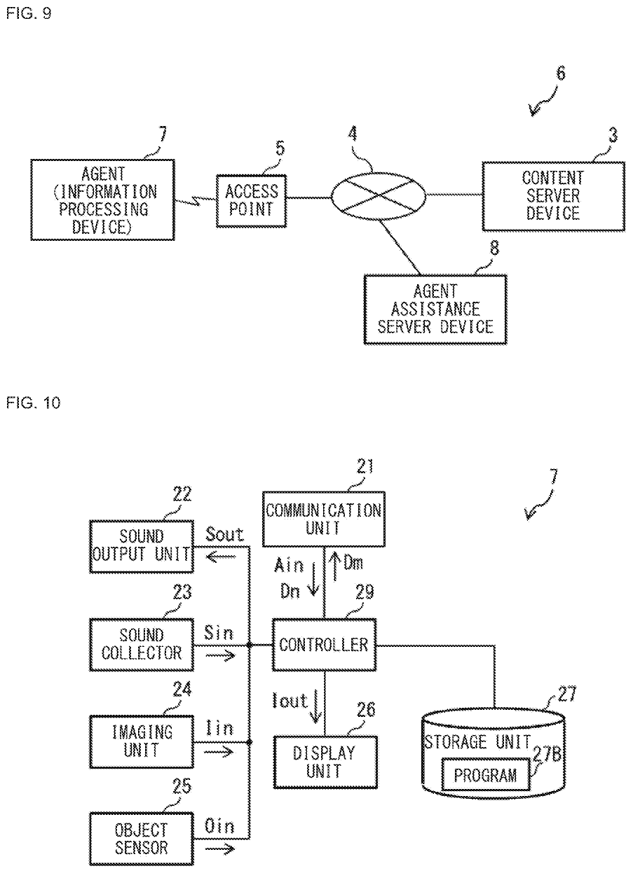

Next, description will be given of an information processing system 6 including an agent 7 and an agent assistance server device 8 according to a second embodiment of the present disclosure. FIG. 9 illustrates an exemplary schematic configuration of the information processing system 6. The information processing system 6 includes the agent 7 (information processing device), the content server device 3, the network 4, the access point 5, and the agent assistance server device 8. The agent 7 and the agent assistance server device 8, on behalf of the user, execute processing of the user's request (specifically, a voice command). The following assumes that the user inputs the voice command to the agent 7 and that the voice command processing is executed by the agent 7 and the agent assistance server device 8.

The agent 7 is coupled to the network 4 via the access point 5. The content server device 3 is coupled to the network 4 via a predetermined communication apparatus. The access point 5 is configured to be wirelessly coupled to a Wi-Fi terminal. The agent 7 communicates with the content server device 3 and the agent assistance server device 8 via the access point 5 through wireless LAN communication. The network 4 is, for example, a network that performs communication using a communication protocol (TCP/IP) that is ordinarily used on the Internet. In response to a request from a terminal (e.g., the agent 7) coupled to the access point 5, the access point 5 transmits (returns) MAC addresses of all apparatuses coupled to the access point 5.

FIG. 10 illustrates an example schematic configuration of the agent 7. The agent 7 includes, for example, the communication unit 21, the sound output unit 22, the sound collector 23, the imaging unit 24, the object sensor 25, the display unit 26, the storage unit 27, and a controller 29. The agent 7 corresponds to the agent 7 according to the above embodiment in which the controller 28 is replaced with the controller 29, and the program 27A stored in the storage unit 27 is replaced with the program 27B. The program 27B includes a series of steps for execution of the voice command processing. The controller 29 is constituted by a processor, for example. The controller 29 executes the program 27B stored in the storage unit 27. Functions of the controller 29 are implemented, for example, by executing the program 27B by the processor. The series of steps implemented by the program 27B will be described in detail later.

FIG. 11 illustrates an example schematic configuration of the agent assistance server device 8. The agent assistance server device 8 includes, for example, a communication unit 71, a storage unit 72, and a controller 73.

The communication unit 71 receives the request Dm from the agent 7. The communication unit 71 transmits the received request Dm to the controller 73. Upon receiving the image signal lout and the voice signal Sout from the controller 73, the communication unit 71 transmits the received image signal lout and voice signal Sout to the agent 7.

The storage unit 72 is, for example, a volatile memory such as a DRAM, or a non-volatile memory such as an EEPROM or a flash memory. The storage unit 72 has a program 72A stored therein that executes the voice command processing, and content 72B stored therein. The program 72A includes a series of steps for execution of the voice command processing. The controller 73 is constituted by a processor, for example. The controller 73 executes the program 72A stored in the storage unit 72. Functions of the controller 73 are implemented, for example, by executing the program 72A by the processor. The series of steps implemented by the program 72A will be described in detail later. The content 72B is, for example, weather information, stock price information, music information, etc.

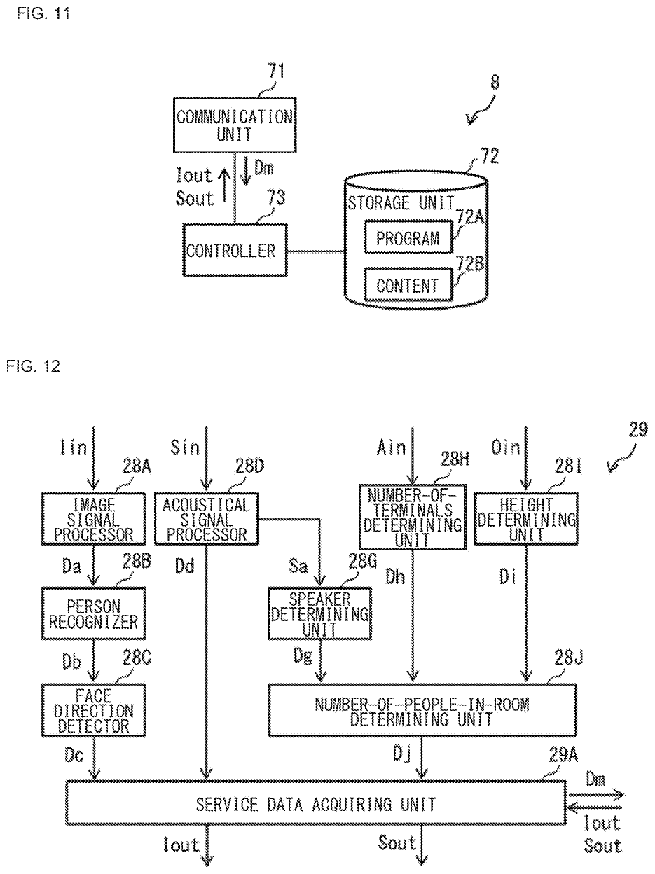

FIG. 12 illustrates exemplary functional blocks of the controller 29 of the agent 7. The controller 29 includes, for example, the image signal processor 28A, the person recognizer 28B, the face direction detector 28C, the acoustical signal processor 28D, the speaker determining unit 28G, the number-of-terminals determining unit 28H, the height determining unit 28I, the number-of-people-in-room determining unit 28J, and a service data acquiring unit 29A. The controller 29 corresponds to the controller 28 according to the above embodiment in which the voice recognizer 28E, the semantic analyzer 28F, the application service deciding unit 28K, and the UI compositing unit 28M are omitted, and the service data acquiring unit 29A is provided instead of the service data acquiring unit 28L.

The service data acquiring unit 29A generates the request Dm including the face direction data Dc obtained from the face direction detector 28C, the voice data Dd obtained from the acoustical signal processor 28D, and the number of people in the room Dj obtained from the number-of-people-in-room determining unit 28J, and transmits it to the communication unit 21. Upon receiving the image signal lout and the voice signal Sout corresponding to the request Dm from the communication unit 21, the service data acquiring unit 29A transmits the received image signal lout to the display unit 26, and transmits the received voice signal Sout to the sound output unit 22.

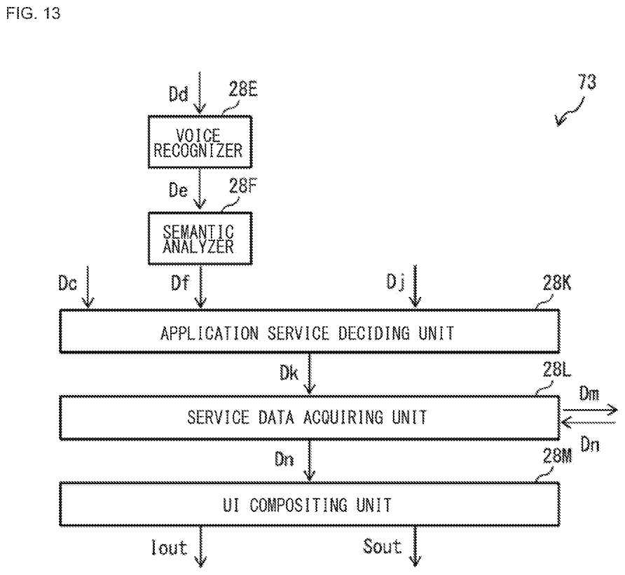

FIG. 13 illustrates exemplary functional blocks of the controller 73 of the agent assistance server device 8. The controller 73 includes, for example, the voice recognizer 28E, the semantic analyzer 28F, the application service deciding unit 28K, the service data acquiring unit 28L, and the UI compositing unit 28M. The controller 73 executes the respective functions of the voice recognizer 28E, the semantic analyzer 28F, the application service deciding unit 28K, the service data acquiring unit 28L, and the UI compositing unit 28M, for example, by executing the program 72A stored in the storage unit 72. That is, in the present embodiment, the respective functions of the image signal processor 28A, the person recognizer 28B, the face direction detector 28C, the acoustical signal processor 28D, the speaker determining unit 28G, the number-of-terminals determining unit 28H, the height determining unit 28I, the number-of-people-in-room determining unit 28J, and the service data acquiring unit 29A are executed by the program 27B being loaded into the controller 29. On the other hand, the respective functions of the voice recognizer 28E, the semantic analyzer 28F, the application service deciding unit 28K, the service data acquiring unit 28L, and the UI compositing unit 28M are executed by the program 72A being loaded into the controller 73.

In the present embodiment, a part of the functions executed by the controller 28 according to the above embodiment is executed by the controller 73 of the agent assistance server device 8. Therefore, in the present embodiment, at least effects similar to those in the above embodiment are obtained. In addition, the present embodiment reduces the load on the controller 28, allowing for a smoother communication between the agent 7 and the speaker. Further, it is unnecessary to apply a unit with an excessively high arithmetic processing capacity to the controller 28. Therefore, it is also possible to provide the agent 7 that is inexpensive.

In addition, for example, the present disclosure may also be configured as follows.
(1)

An information processing device including

a mode controller that sets a mode to a minimum utterance rejection mode if a predetermined condition is satisfied during voice recognition.
(2)

The information processing device according to (1), in which the predetermined condition includes at least one of a case where an utterance detected during the voice recognition is determined as being a non-corresponding utterance that does not correspond to an instruction of a corresponding function, a case where a face of a speaker detected during the voice recognition is determined as not facing the information processing device, or a case where a number of people in a room detected during the voice recognition is determined as being two or more.
(3)

The information processing device according to (2), further including:

an imaging unit; and

a face direction detector that detects a face direction of the speaker on the basis of an image obtained by the imaging unit,

in which the mode controller determines whether or not the face of the speaker is facing the information processing device on the basis of the face direction of the speaker detected by the face direction detector.
(4)

The information processing device according to (2) or (3), further including:

a sound collector; and

an utterance detector that detects the utterance on the basis of sound obtained by the sound collector,

in which the mode controller determines whether or not the utterance includes the non-corresponding utterance on the basis of the utterance detected by the utterance detector.
(5)

The information processing device according to any one of (2) to (4), further including:

a sound collector; and

a number-of-speakers detector that detects a number of speakers on the basis of sound obtained by the sound collector,

in which the mode controller determines whether or not the number of people in the room is two or more on the basis of the number of speakers detected by the number-of-speakers detector.
(6)

The information processing device according to any one of (2) to (5), further including:

a communication unit configured to communicate with an access point; and

a number-of-apparatuses detector that detects a number of apparatuses coupled to the access point, excluding the information processing device, on the basis of information of an apparatus coupled to the access point, the information being acquired via the communication unit,

in which the mode controller determines whether or not the number of people in the room is two or more on the basis of the number of apparatuses detected by the number-of-apparatuses detector.
(7)

The information processing device according to any one of (2) to (6), further including:

an object sensor that detects an object on the basis of a reflected wave; and

a number-of-people-in-room detector that detects the number of people in the room on the basis of a size of the object obtained by the object sensor,

in which the mode controller determines whether or not the number of people in the room is two or more on the basis of the number of people in the room detected by the number-of-people-in-room detector.
(8)

A program that causes an information processing device configured to perform voice recognition to execute a step of setting a mode to a minimum utterance rejection mode if a predetermined condition is satisfied during the voice recognition.

In the agent according to one embodiment of the present disclosure and the program to be executed by the agent, the voice recognition mode is set to the minimum utterance rejection mode if a predetermined condition is satisfied during voice recognition. Here, the predetermined condition includes at least one of a case where the utterance detected during voice recognition is determined as being a non-corresponding utterance that does not correspond to an instruction of a corresponding function, a case where the face of the speaker detected during voice recognition is determined as not facing the information processing device, or a case where the number of people in the room detected during voice recognition is determined as being two or more. This enables command input based on a minimum utterance to be rejected in a situation where a malfunction is likely to occur, which makes it possible to reduce the probability of occurrence of a malfunction in a case where an instruction (i.e., voice command) of an application or one function (corresponding function) included in the application is executed by a minimum utterance.

This application claims the benefit of Japanese Priority Patent Application No. 2018-204770 filed with the Japan Patent Office on Oct. 31, 2018, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. An information processing device comprising
a mode controller that sets a voice recognition mode to a minimum utterance rejection mode if a predetermined condition is satisfied during voice recognition.

2. The information processing device according to claim 1, wherein the predetermined condition includes at least one of a case where an utterance detected during the voice recognition is determined as being a non-corresponding utterance that does not correspond to an instruction of a corresponding function, a case where a face of a speaker detected during the voice recognition is determined as not facing the information processing device, or a case where a number of people in a room detected during the voice recognition is determined as being two or more.

3. The information processing device according to claim 2, further comprising:
an imaging unit; and
a face direction detector that detects a face direction of the speaker on a basis of an image obtained by the imaging unit,
wherein the mode controller determines whether or not the face of the speaker is facing the information processing device on a basis of the face direction of the speaker detected by the face direction detector.

4. The information processing device according to claim 2, further comprising:
a sound collector; and
an utterance detector that detects the utterance on a basis of sound obtained by the sound collector,
wherein the mode controller determines whether or not the utterance includes the non-corresponding utterance on a basis of the utterance detected by the utterance detector.

5. The information processing device according to claim 2, further comprising:
a sound collector; and
a number-of-speakers detector that detects a number of speakers on a basis of sound obtained by the sound collector,
wherein the mode controller determines whether or not the number of people in the room is two or more on a basis of the number of speakers detected by the number-of-speakers detector.

6. The information processing device according to claim 2, further comprising:
a communication unit configured to communicate with an access point; and
a number-of-apparatuses detector that detects a number of apparatuses coupled to the access point, excluding the information processing device, on a basis of information of an apparatus coupled to the access point, the information being acquired via the communication unit,
wherein the mode controller determines whether or not the number of people in the room is two or more on a basis of the number of apparatuses detected by the number-of-apparatuses detector.

7. The information processing device according to claim 2, further comprising:
an object sensor that detects an object on a basis of a reflected wave; and
a number-of-people-in-room detector that detects the number of people in the room on a basis of a size of the object obtained by the object sensor,
wherein the mode controller determines whether or not the number of people in the room is two or more on a basis of the number of people in the room detected by the number-of-people-in-room detector.

8. A program that causes an information processing device configured to perform voice recognition to execute a step of setting a voice recognition mode to a minimum utterance rejection mode if a predetermined condition is satisfied during the voice recognition.
